(19) United States
(12) Patent Application Publication
(10) Pub. No.: US 2014/0274274 A1
(43) Pub. Date: Sep. 18, 2014

(54) GAMING MACHINE WITH CONTROLLABLE AND VARIABLE MECHANICAL VIBRATION AND RHYTHM PATTERNS

(71) Applicant: WMS GAMING INC., Waukegan, IL (US)

(72) Inventors: Charles R. Bleich, Cary, IL (US); Simon E. Sunblade, Chicago, IL (US); Wingate K. Williams, Palatine, IL (US)

(73) Assignee: WMS GAMING INC., Waukegan, IL (US)

(21) Appl. No.: 14/211,949

(22) Filed: Mar. 14, 2014

Related U.S. Application Data
(60) Provisional application No. 61/801,922, filed on Mar. 15, 2013.

(51) Int. Cl. G07F 17/32

(52) U.S. Cl. CPC G07F 17/3244
USPC 463/17

(57) ABSTRACT

According to some aspects of the present disclosure, a gaming machine includes one or more display devices configured to display a wagering game, a knocker, and one or more memory devices. The knocker includes a first impactor configured to strike a first portion of the gaming machine, and a motor coupled to the first impactor. The motor is configured to selectively actuate the first impactor to strike the first portion of the gaming machine with one of a first impact force and a second impact force. The one or more memory devices store instructions that, when executed by at least one processor, cause the gaming machine to actuate the knocker in response to an occurrence in the wagering game.

### CROSS-REFERENCE TO RELATED APPLICATIONS

This application claims the benefit of U.S. Provisional Patent Application 61/801,922, filed on Mar. 15, 2013, which is hereby incorporated by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to a gaming machine with controllable and variable mechanical vibration and rhythm patterns.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

### SUMMARY OF THE INVENTION

According to at least one aspect of the present invention, a gaming machine includes one or more display devices configured to display a wagering game, a knocker, and one or more memory devices. The knocker includes a first impactor configured to strike a first portion of the gaming machine, and a motor coupled to the first impactor. The motor is configured to selectively actuate the first impactor to strike the first portion of the gaming machine with one of a first impact force and a second impact force. The one or more memory devices store instructions that, when executed by at least one processor, cause the gaming machine to actuate the knocker in response to an occurrence in the wagering game.

According to at least one aspect of the present invention, the motor is a rotary actuator.

According to at least one aspect of the present invention, the rotary actuator is a servo motor or a stepper motor.

According to at least one aspect of the present invention, the first portion of the gaming machine is a striker plate configured to produce a tone.

According to at least one aspect of the present invention, the gaming machine includes a plurality of striker plates, each striker plate being movably disposed such that the first impactor, when actuated, strikes a selected one of the plurality of striker plates.

According to at least one aspect of the present invention, the first impactor striking the portion of the gaming machine provides haptic feedback to a player in contact with the gaming machine.

According to at least one aspect of the present invention, the gaming machine includes a second impactor configured to strike a second portion of the gaming machine. The second impactor is coupled to the motor. The motor is further configured to selectively actuate the second impactor to strike the second portion of the gaming machine with one of the first impact force or the second impact force.

According to at least one aspect of the present invention, the first portion of the gaming machine is a first striker plate configured to produce a first tone when struck by the first impactor and the second portion of the gaming machine is a second striker plate configured to produce a second tone when struck by the second impactor, the second tone being different than the first tone.

According to at least one aspect of the present invention, the first striker plate defines a shape different than a shape defined by the second striker plate.

According to at least one aspect of the present invention, the first striker plate includes a first material and the second striker plate includes a second material, the second material being different than the first.

According to at least one aspect of the present invention, the first impactor and the second impactor rotate about an axis and the first impactor is disposed about 180° from the second impactor.

According to at least one aspect of the present invention, the first impactor comprises a first material and the second impactor comprises a second material, the second material being different than the first.

According to at least one aspect of the present invention, a method for creating multiple sound profiles with a single knocker device disposed in combination with a wagering game machine includes actuating a first impactor of a knocker to strike a first portion of the gaming machine with one of a first force to produce a first tone or with a second force to produce a second tone. The actuating of the first impactor occurs responsive to an occurrence in a wagering game.

According to at least one aspect of the present invention, the method further includes actuating a second impactor of the knocker to strike a second portion of the gaming machine with one of a third force to produce a third tone or with a fourth force to produce a fourth tone. The actuating of the second impactor occurring responsive to an occurrence in a wagering game.

According to at least one aspect of the present invention, a gaming machine includes one or more display devices configured to display a wagering game; a knocker, and one or more display devices. The knocker includes a motor, a first impactor, and a second impactor. The motor is coupled to a rod. The motor is disposed between a first end and a second end of the rod. The motor is configured to rotate the rod about an axis of rotation in a first direction and a second direction. The first direction is opposite the second direction. A first impactor is disposed at the first end of the rod. The first impactor is configured to strike a first portion of the gaming machine. A second impactor disposed at the second end of the rod. The second impactor is configured to strike a second portion of the gaming machine. The one or more memory devices store instructions that, when executed by at least one processor, cause the gaming machine to actuate the knocker in response to an occurrence in the wagering game.

According to at least one aspect of the present invention, a gaming machine includes one or more display devices configured to display a wagering game, a knocker, and one or more memory devices. The knocker includes a first impactor and a motor. The first impactor is configured to strike a first portion of the gaming machine and a second portion of the gaming machine. The motor is coupled to the first impactor and configured to selectively actuate the first impactor to strike at least one of the first portion and the second portion of the gaming machine. The one or more memory devices store instructions that, when executed by at least one processor, cause the gaming machine to actuate the knocker in response to an occurrence in the wagering game.

According to at least one aspect of the present invention, the motor is further configured to selectively actuate the first impactor to strike with a first impact force and a second impact force.

According to at least one aspect of the present invention, a method for creating multiple sound profiles with a single knocker device disposed in combination with a wagering game machine includes actuating a first impactor of a knocker to strike a first portion and a second portion of the gaming machine to produce a first tone and a second tone. The actuating of the first impactor occurs responsive to an occurrence in a wagering game.

According to yet another aspect of the invention, computer readable storage media is encoded with instructions for directing a gaming system to perform the above methods.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming terminal according to an embodiment of the present invention.

FIG. 2 is a schematic view of a gaming system according to an embodiment of the present invention.

FIG. 3 is an image of an exemplary basic-game screen of a wagering game displayed on a gaming terminal, according to an embodiment of the present invention.

FIG. 4 illustrates a knocker mounted on a portion of the gaming terminal of FIG. 1, according to an embodiment.

FIG. 5 illustrates the knocker of FIG. 4 mounted on the gaming terminal of FIG. 1, according to an embodiment.

FIG. 6 illustrates the knocker of FIG. 4 mounted on the gaming terminal of FIG. 1, according to an embodiment.

FIG. 7 illustrates a knocker mounted on a portion of the gaming terminal of FIG. 1, according to an embodiment.

FIG. 8 illustrates a top view of the knocker of FIG. 7 disposed within a plurality of striker plates that are moveable according to an embodiment.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

Referring to FIG. 1, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433, titled “Reel Spinning Slot Machine With Superimposed Video Image,” U.S. Patent Application Publication Nos. US2010/0069160, titled “Handheld Wagering Game Machine And Docking Unit,” and US2010/0234099, titled “Wagering Game System With Docking Stations” which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving an input indicative of a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

Referring now to FIG. 4, a knocker 102 is mounted on a portion of the gaming terminal 10 (alternatively, gaming machine 10). In some aspects, the knocker is mounted inside of the gaming machine 10, for example, on a side of the cabinet 11. In some aspects, the knocker is mounted on the back of a button 20 or button panel. The knocker 102 includes a motor 104 coupled to impactors 106a,b using rod 108. The motor 104 actuates impactors 106a,b by rotating the rod 108 about an axis. As shown, the motor can rotate the rod 108 both clockwise and counter-clockwise. In some aspects, the motor 104 is a rotary actuator such as a servo motor or a stepper motor.

The first impactor 106a contacts the gaming machine 10 at a first portion 110a and the second impactor 106b contacts the gaming machine 10 at a second portion 110b. The impactors 106b can be actuated by the motor 104 to strike the first portion 110a and the second portion 110b of the gaming machine 10 with a plurality of impact forces, each impact force producing a different tone. The impactors 106 can also be actuated to produce tones more rapidly or more slowly. Additionally, the first impactor 106a and the second impactor 106b can be selectively actuated in any desired order. In some aspects, the first impactor 106a and the second impactor 106b include different materials. In one nonlimiting example, one material covers another material. Additionally or alternatively, the different materials can be disposed adjacent to each other to produce different characteristics when struck. In one nonlimiting example, a hemisphere of the first impactor 106a closest to the first portion 110a is rubber while a hemisphere furthest from the first portion 110a is rubber.

Referring now to FIG. 5, the knocker 102 is mounted on a portion of the gaming terminal 10. The first portion 110a of the gaming terminal 10 includes a striker plate 202. In this embodiment, the first impactor 106a contacts the striker plate 202 and the second impactor 106b contacts the second portion 110b of the gaming terminal 10. The striker plate 202 produces a tone when struck by the first impactor 106a. The striker plate 202 can be made from a variety of materials and formed in a variety of shapes to produce desired tones. For example, a striker plate 202 having a thinner shape will have a different resonance and pitch than a striker plate 202 having a thicker shape. Similarly, a striker plate 202 made from a rigid material will have a different resonance and pitch than a striker plate 202 made from a resilient material. In some aspects, the first portion 110a includes a striker plate 202 used primarily to produce a tone while the second portion 110b is used primarily to provide haptic feedback to a player in contact with the gaming machine 10. In some aspects, the first portion 110a includes a striker plate that is used for haptic feedback as well as being part of a produced sound profile.

Referring now to FIG. 6, the knocker 102 is mounted on a portion of the gaming terminal 10. The first portion 110a of the gaming terminal 10 includes a first striker plate 202a and the second portion 110b includes a second striker plate 202b. In this embodiment, the first impactor contacts the first striker plate 202a and the second impactor contacts the second striker plate 202b. In some aspects, the first striker plate 202a and the second striker plate 202b are identical. In other aspects, the first striker plate 202a and the second striker plate 202b have different characteristics such as different shapes or materials.

Referring now to FIG. 7, a knocker 402 is shown according to an embodiment. A motor 404 is coupled to an impactor 106 using a rod 108. The motor 404 can rotate the rod 108 both clockwise and counter clockwise. The impactor 106 can rotate far enough to contact either the first portion 110a and the second portion 110b of the gaming machine 10. The motor 404 has a housing with an upper portion 406a that is rotatable relative to the lower portion 406b. The housing pivots about a vertical axis 408 to allow the impactor to contact a third portion 110c and a fourth portion (not shown) of the gaming machine 10. In some aspects, the motor may be slidably disposed so that the motor can move linearly between plates (e.g., horizontally across a surface of the gaming machine 10).

In some aspects, striker plates are movably disposed. This can be accomplished, for example by having a plurality of striker plates mounted on a carousel that moves rotatably (for example, the plurality of striker plates 202a-202g mounted on carousel 802 that moves rotatably in the direction of arrow 804 as shown in FIG. 8) or mounted on a slidable plate that moves linearly. The plurality of striker plates can be moved such that a selected one of the striker plates is disposed in a position to be struck by an impactor. In some aspects, a plurality of striker plates mounted on a carousel is disposed concentrically with the motor (as shown in FIG. 8). In some aspects, the plurality of striker plates and the motor are both moveable (as shown by arrow 408 and arrow 804). This allows a single impactor to contact a first and a second striker plate (for example, plates 202a and 202b, respectively) more quickly than when only one of the motor and the plurality of striker plates is movable.

As described herein, the knockers can create various and variable mechanical vibration patterns and sound profiles. These can be varied and controlled through use of striker plate materials, impactor materials, rod materials, striker shape, impactor shape, rod shape, strike speed, strike or impact force, selective actuation that controls strike rhythm and irregularity, and combinations thereof, as well as various other features.

While the two illustrated impactors are disposed at about 180° from each other, it is contemplated that other angles can be used. Additionally, it is contemplated that the impactors may contact different portions of the gaming machine 10. For example, the first portion 110a of the gaming machine 10 could be the inside of the cabinet 11 and the second portion 110b of the gaming machine 10 could be the button panel.

One algorithm that corresponds to at least some instructions executed by the CPU 30 in FIG. 2 to perform the above described functions associated with the disclosed concepts. A wagering game is initiated by a player. In response to a first occurrence in the wagering game, the motor is actuated to produce a first sound profile, provide a first haptic feedback profile, or both. In response to a second occurrence in the wagering game, the motor is acutated to produce a second sound profile, provide a second haptic feedback profile, or both. In some aspects, the first and the second sound profile are the same profile. In some aspects, the first and the second haptic feedback profile are the same.

Each of these embodiments and obvious variations thereof is contemplated as falling within the spirit and scope of the claimed invention, which is set forth in the following claims. Moreover, the present concepts expressly include any and all combinations and subcombinations of the preceeding elements and aspects.

1. A gaming machine comprising:
one or more display devices configured to display a wagering game;
a knocker including:
a first impactor configured to strike a first portion of the gaming machine,
a motor coupled to the first impactor, the motor configured to selectively actuate the first impactor to strike the first portion of the gaming machine with one of a first impact force and a second impact force; and
one or more memory devices storing instructions that, when executed by at least one processor, cause the gaming machine to actuate the knocker in response to an occurrence in the wagering game.

2. The gaming machine of claim 1, wherein the motor is a servo motor or a stepper motor.

3. The gaming machine of claim 1, further comprising a plurality of striker plates, each striker plate being movably disposed such that the first impactor, when actuated, strikes a selected one of the plurality of striker plates.

4. The gaming machine of claim 1, wherein the first impactor striking the portion of the gaming machine provides haptic feedback to a player in contact with the gaming machine.

5. The gaming machine of claim 1, further comprising a second impactor configured to strike a second portion of the gaming machine, the second impactor coupled to the motor, wherein the motor is further configured to selectively actuate the second impactor to strike the second portion of the gaming machine with one of the first impact force or the second impact force.

6. The gaming machine of claim 5, wherein the first portion of the gaming machine is a first striker plate configured to produce a first tone when struck by the first impactor and the second portion of the gaming machine is a second striker plate configured to produce a second tone when struck by the second impactor, the second tone being different than the first tone.

7. The gaming machine of claim 6, wherein the first striker plate defines a shape different than a shape defined by the second striker plate.

8. The gaming machine of claim 6, wherein the first striker plate includes a first material and the second striker plate includes a second material, the second material being different than the first.

9. The gaming machine of claim 5, wherein the first impactor comprises a first material and the second impactor comprises a second material, the second material being different than the first.

10. A method for creating multiple sound profiles with a single knocker device disposed in combination with a wagering game machine, the method comprising:
actuating a first impactor of a knocker to strike a first portion of the gaming machine with one of a first force to produce a first tone or a second force to produce a second tone, the actuating of the first impactor occurring responsive to an occurrence in a wagering game.

11. The method of claim 10, wherein the first portion of the gaming machine is a first striker plate.

12. The method of claim 10, further comprising providing haptic feedback, using the first impactor, to a player in contact with the gaming machine.

13. The method of claim 10, further comprising actuating a second impactor of the knocker to strike a second portion of the gaming machine with one of a third force to produce a third tone or with a fourth force to produce a fourth tone, the actuating of the second impactor occurring responsive to an occurrence in a wagering game.

14. The method of claim 13, wherein the first portion of the gaming machine is a first striker plate configured to produce a first tone when struck by the first impactor and the second portion of the gaming machine is a second striker plate configured to produce a second tone when struck by the second impactor, the second tone being different than the first tone.

15. A gaming machine comprising:
one or more display devices configured to display a wagering game;
a knocker including:
a motor coupled to a rod, the motor disposed between a first end and a second end of the rod, the motor configured to rotate the rod about an axis of rotation in a first direction and a second direction, the first direction opposite the second direction,
a first impactor disposed at the first end of the rod, the first impactor configured to strike a first portion of the gaming machine,
a second impactor disposed at the second end of the rod, the second impactor configured to strike a second portion of the gaming machine; and
one or more memory devices storing instructions that, when executed by at least one processor, cause the gaming machine to actuate the knocker in response to an occurrence in the wagering game.

16. The gaming machine of claim 15, wherein the first portion of the gaming machine is a first striker plate configured to produce a first tone when struck by the first impactor and the second portion of the gaming machine is a second striker plate configured to produce a second tone when struck by the second impactor, the second tone being different than the first tone.

17. The gaming machine of claim 15, wherein at least one of the first impactor striking the first portion of the gaming machine or the second impactor striking the second portion of the gaming machine provides haptic feedback to a player in contact with the gaming machine.

18. The gaming machine of claim 15, wherein the first impactor and the second impactor rotate about an axis and the first impactor is disposed about 180° from the second impactor.

19. The gaming machine of claim 15, wherein the first impactor comprises a first material and the second impactor comprises a second material, the second material being different than the first.

20. A method for creating multiple sound profiles with a single knocker device disposed in combination with a wagering game machine, the method comprising:
actuating a first impactor of a knocker to strike a first portion and a second portion of the gaming machine produce a first tone and a second tone, the actuating of the first impactor occurring responsive to an occurrence in a wagering game.

21. The method of claim 20, wherein the first impactor is configured to strike with at least a first impact force and a second impact force.
